(19) United States
(12) Patent Application Publication
(10) Pub. No.: US 2024/0232456 A1
(43) Pub. Date: Jul. 11, 2024

(54) POLLUTION EMISSION DETERMINATION METHOD AND APPARATUS BASED ON DIGITAL WATERSHED SPACE-TIME MODEL

(71) Applicant: CHINESE RESEARCH ACADEMY OF ENVIRONMENTAL SCIENCES, Beijing (CN)

(72) Inventors: Haisheng LI, Beijing (CN); Hua JIANG, Beijing (CN); Jianglong CUI, Beijing (CN); Lieyu ZHANG, Beijing (CN); Guowen LI, Beijing (CN); Cao LIU, Beijing (CN); Wensi WANG, Beijing (CN); Xiaoguang LI, Beijing (CN); Jiaqian LI, Beijing (CN); Chen ZHAO, Beijing (CN); Caole LI, Beijing (CN); Wei LI, Beijing (CN); Xiaolin HOU

(73) Assignee: CHINESE RESEARCH ACADEMY OF ENVIRONMENTAL SCIENCES, Beijing (CN)

(21) Appl. No.: 18/009,343

(22) PCT Filed: Oct. 25, 2022
(86) PCT No.: PCT/CN2022/127275

§ 371 Date: Dec. 9, 2022

(30) Foreign Application Priority Data
Aug. 26, 2021 (CN) 202110990854.9
Dec. 31, 2021 (CN) 202111668234.X

(51) Int. Cl. G06F 30/20

(52) U.S. Cl. CPC G06F 30/20

(57) ABSTRACT

A pollution emission determination method and apparatus based on a digital watershed space-time model is provided. In the method, a to-be-detected river watershed includes a plurality of sections, each section is provided with a monitoring station, a water quality sensor is mounted on each monitoring station, and the water quality sensor is used for acquiring water quality data. The method includes: acquiring currently monitored water quality data of a current monitoring station; acquiring actual water quality data of a previous monitoring station, calculating the actual water quality data through a calculated one-dimensional steady-state river model, and acquiring theoretical water quality data of the current monitoring station; and determining whether pollution emission occurs between the current monitoring station and the previous monitoring station according to a comparison result of the currently monitored water quality data and the theoretical water quality data.

### CROSS REFERENCE TO THE RELATED APPLICATIONS

This application is the national phase entry of International Application No. PCT/CN2022/127275, filed on Oct. 25, 2022, which is based upon and claims priority to Chinese Patent Applications No. 202110990854.9, filed on Aug. 26, 2021 and No. 202111668234.X, filed on Dec. 31, 2021, the entire contents of which are incorporated herein by reference.

### TECHNICAL FIELD

The present disclosure relates to the technical field of river water quality monitoring, and particularly to a pollution emission determination method and apparatus based on a digital watershed space-time model.

### BACKGROUND

The effective management of ecological resources of watershed is an important issue that has to be solved and responded. It is an important measure for modernization of watershed management to establish a digital watershed and accurately judge a pollution emission condition.

### SUMMARY

In order to solve the technical problems above or at least partially solve the technical problems above, the present disclosure provides a pollution emission determination method and apparatus based on a digital watershed space-time model.

The present disclosure provides a pollution emission determination method based on a digital watershed space-time model, wherein a to-be-detected river watershed includes a plurality of sections, each section is provided with a monitoring station, a water quality sensor is mounted on each monitoring station, and the water quality sensor is used for acquiring water quality data; and the method includes:
acquiring currently monitored water quality data of a current monitoring station;
acquiring actual water quality data of a previous monitoring station, calculating the actual water quality data through a calculated one-dimensional steady-state river model, and acquiring theoretical water quality data of the current monitoring station; and
determining whether pollution emission occurs between the current monitoring station and the previous monitoring station according to a comparison result of the currently monitored water quality data and the theoretical water quality data.

In an optional embodiment of the present disclosure, before calculating the actual water quality data through the calculated one-dimensional steady-state river model, the method further includes:
acquiring a plurality of flow velocities in each section, and calculating an average value of the plurality of flow velocities as an actual flow velocity of two adjacent sections;
acquiring monitored water quality data of each section and a cross-section distance between two adjacent sections, wherein the monitored water quality data includes an initial point pollutant concentration and a cross-section pollutant concentration;
calculating the monitored water quality data, the actual flow velocity and the cross-section distance by the one-dimensional steady-state river model for multiple times to acquire a sum of an aerobic coefficient and a sedimentation coefficient of a pollutant; and
establishing the calculated one-dimensional steady-state river model according to the sum of the aerobic coefficient and the sedimentation coefficient of the pollutant, the actual flow velocity and the cross-section distance.

In an optional embodiment of the present disclosure, the pollution emission determination method based on the digital watershed space-time model further includes:
acquiring initial water quality data of any target section, calculating the initial water quality data through the calculated one-dimensional steady-state river model, and acquiring last water quality data of the target section;
acquiring initial water quality data of next section; and
when the last water quality data is inconsistent with the initial water quality data of the next section, adjusting the sum of the aerobic coefficient and the sedimentation coefficient of the pollutant until an error between the last water quality data and the initial water quality data of the next section is within a preset threshold.

In an optional embodiment of the present disclosure, the determining whether the pollution emission occurs between the current monitoring station and the previous monitoring station according to the comparison result of the currently monitored water quality data and the theoretical water quality, includes:
acquiring a current pollution value of each pollutant from the current water quality data;
acquiring a theoretical pollution value of each pollutant from the theoretical water quality data;
calculating difference values between the current pollution values and the theoretical pollution values, and acquiring a target pollutant with the difference value greater than a preset difference value threshold;
when the target pollutant is in a preset pollutant list, determining that the pollution emission occurs between the current monitoring station and the previous monitoring station; and
when the target pollutant is not in the preset pollutant list, determining that no pollution emission occurs between the current monitoring station and the previous monitoring station.

In an optional embodiment of the present disclosure, the determining whether the pollution emission occurs between the current monitoring station and the previous monitoring station according to the comparison result of the currently monitored water quality data and the theoretical water quality, includes:
acquiring a current pollution value of a target pollutant from the current water quality data;
acquiring a theoretical pollution value of the target pollutant from the theoretical water quality data;
calculating a difference value between the current pollution value and the theoretical pollution value, and when the difference value is greater than a preset difference value threshold, determining that the pollution emission occurs between the current monitoring station and the previous monitoring station; and
when the difference value is smaller than or equal to the preset difference value threshold, determining that no pollution emission occurs between the current monitoring station and the previous monitoring station.

In an optional embodiment of the present disclosure, the pollution emission determination method based on the digital watershed space-time model further includes:
when it is determined that the pollution emission occurs between the current monitoring station and the previous monitoring station, generating early warning information and sending the early warning information to a target device.

In an optional embodiment of the present disclosure, the pollution emission determination method based on the digital watershed space-time model further includes:
when it is determined that the pollution emission occurs between the current monitoring station and the previous monitoring station, acquiring a distance between the current monitoring station and the previous monitoring station;
when the distance is smaller than a preset distance threshold, acquiring industry information within the distance; and
determining a target region of pollutant emission according to the industrial information.

The present disclosure provides a pollution emission determination apparatus based on a digital watershed space-time model, wherein a to-be-detected river watershed includes a plurality of sections, each section is provided with a monitoring station, a water quality sensor is mounted on each monitoring station, and the water quality sensor is used for acquiring water quality data; and the apparatus includes:
a first water quality acquisition module configured for acquiring currently monitored water quality data of a current monitoring station;
a second water quality acquisition module configured for acquiring actual water quality data of a previous monitoring station, calculating the actual water quality data through a calculated one-dimensional steady-state river model, and acquiring theoretical water quality data of the current monitoring station; and
a pollution emission determination module configured for determining whether pollution emission occurs between the current monitoring station and the previous monitoring station according to a comparison result of the currently monitored water quality data and the theoretical water quality data.

The present disclosure provides a computer storage medium, wherein the computer storage medium may store a computer program, and when the program is executed, some or all steps in various implementation modes of a communication method provided in the present disclosure may be realized.

The present disclosure further provides an electronic device, which includes:
a processor; and
a storage for storing an executable instruction of the processor;
wherein a to-be-detected river watershed includes a plurality of sections, each section is provided with a monitoring station, a water quality sensor is mounted on each monitoring station, and the water quality sensor is used for acquiring water quality data; and the processor is configured for:
acquiring currently monitored water quality data of a current monitoring station;
acquiring actual water quality data of a previous monitoring station, calculating the actual water quality data through a calculated one-dimensional steady-state river model, and acquiring theoretical water quality data of the current monitoring station; and
determining whether pollution emission occurs between the current monitoring station and the previous monitoring station according to a comparison result of the currently monitored water quality data and the theoretical water quality data.

### BENEFICIAL EFFECTS

Compared with the prior art, the technical solutions above provided by the embodiments of the present disclosure have the following advantages:

In the pollution emission determination method based on the digital watershed space-time model of the present disclosure, the to-be-detected river watershed includes the plurality of sections, each section is provided with the monitoring station, the water quality sensor is mounted on each monitoring station, and the water quality sensor is used for acquiring the water quality data; and the method includes: acquiring the currently monitored water quality data of the current monitoring station; acquiring the actual water quality data of the previous monitoring station, calculating the actual water quality data through the calculated one-dimensional steady-state river model, and acquiring the theoretical water quality data of the current monitoring station; and determining whether the pollution emission occurs between the current monitoring station and the previous monitoring station according to the comparison result of the currently monitored water quality data and the theoretical water quality data. Therefore, the water quality pollution condition is judged in real time, and the pollution condition is effectively predicted and traced.

It should be understood that, the above general description and the following detailed description are exemplary and explanatory only, and cannot limit the present disclosure.

### BRIEF DESCRIPTION OF THE DRAWINGS

The drawings herein are incorporated into the specification and constitute a part of the specification, show the embodiments that conform to the present disclosure, and are used for explaining the principle of the present disclosure together with the specification.

In order to illustrate the embodiments of the present disclosure or the technical solutions in the prior art more clearly, the drawings needed to be used in the description of the embodiments or the prior art will be briefly introduced hereinafter. Obviously, for those of ordinary skills in the art, other drawings may also be obtained according to these drawings without going through creative works.

FIG. 1 is a flow chart of a pollution emission determination method based on a digital watershed space-time model in an embodiment of the present disclosure;

FIG. 2 is a schematic diagram of a digital watershed in the embodiment of the present disclosure;

FIG. 3 is a flow chart of the pollution emission determination method based on the digital watershed space-time model in the embodiment of the present disclosure; and

FIG. 4 is a schematic structural diagram of a pollution emission determination apparatus based on a digital watershed space-time model in the embodiment of the present disclosure.

### DETAILED DESCRIPTION OF THE EMBODIMENTS

In order to make the objects, technical solutions, and advantages of the embodiments of the present disclosure more clearly, the technical solutions in the embodiments of the present disclosure will be described clearly and completely below. Obviously, the described embodiments are some, but not all, embodiments of the present disclosure. Based on the embodiments in the present disclosure, all other embodiments obtained by those of ordinary skills in the art without going through creative works fall within the scope of protection of the present disclosure.

Specifically, a digital watershed of the present disclosure refers to information collection and digital management of a water body of a whole watershed by comprehensively using a sensor technology, a geographic information system and other technologies, so as to establish a comprehensive information platform for the whole watershed, so that relevant departments can control a water quality condition of the whole watershed in time, assist inspection of environmental protection, judge a water quality pollution condition, and effectively predict and trace the pollution condition. According to the digital watershed, a diffusion condition after generation of pollution can be deduced by collecting sensor data in combination with a pollutant diffusion process of the watershed, pollution emission can be investigated by reversely deducing the pollutant diffusion process, and a geographic information system is used to realize visual display of a pollution situation and a series of related works.

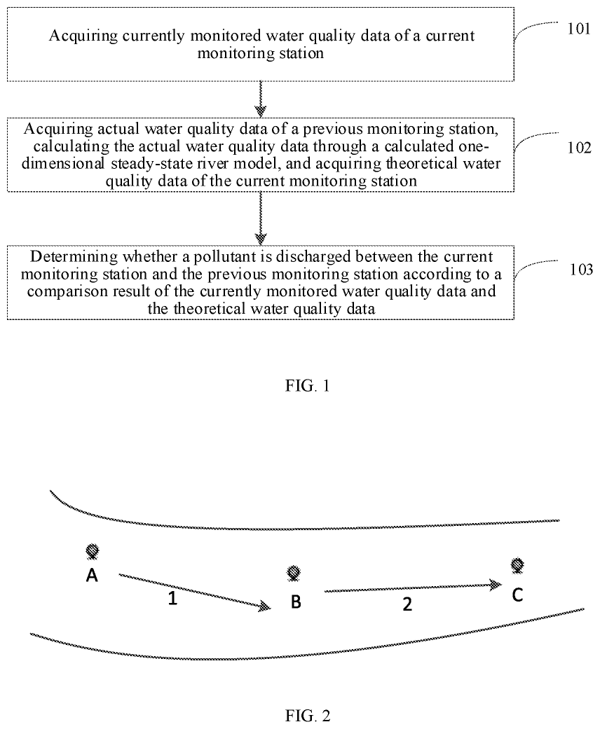

FIG. 1 is a flow chart of a pollution emission determination method based on a digital watershed space-time model in an embodiment of the present disclosure.

As shown in FIG. 1, the method includes the following steps.

In step 101, currently monitored water quality data of a current monitoring station is acquired.

In the embodiment of the present disclosure, a to-be-detected river watershed includes a plurality of sections, each section is provided with a monitoring station, a water quality sensor is mounted on each monitoring station, and the water quality sensor is used for acquiring water quality data.

As an example of a scene, as shown in FIG. 2, some sections 1 and 2 in the river watershed are displayed, and each section is provided with the monitoring station. For example, an initial position of the section 1 is provided with a monitoring station A and a last position of the section 1 is provided with a monitoring station B, and the water quality sensors are mounted on the monitoring stations A and B for acquiring the water quality data. For another example, an initial position of the section 2 is provided with the monitoring station B and a last position of the section 2 is provided with a monitoring station C, and the water quality sensors are mounted on the monitoring stations B and C for acquiring the water quality data.

The use of the sensors is a common method for knowing a water quality situation in a watershed, but the sensors generally have a high construction cost. It is necessary to arrange dense sensors to know a water quality situation in a large watershed, leading to high monitoring and maintenance costs. In the embodiment of the present disclosure, a small number of water quality sensors are arranged in the watershed, a one-dimensional steady-state river model is used to simulate the water quality condition of the whole watershed, and early warning and tracing judgment are carried out on this basis. Parameters of the one-dimensional steady-state river model are measured through real-time data.

In the embodiment of the present disclosure, a type of the water quality sensor may be selected and set according to an application requirement, so that there may be one or more types of acquired water quality data, such as a phosphorus concentration and a nitrogen concentration.

In the embodiment of the present disclosure, the currently monitored water quality data is water quality data acquired by the water quality sensor of the current monitoring station.

In the embodiment of the present disclosure, the current monitoring station may be any monitoring station, such as the monitoring station B or C in FIG. 2, and is specifically selected and set according to an application scene.

In step 102, actual water quality data of a previous monitoring station is acquired, the actual water quality data is calculated through the calculated one-dimensional steady-state river model, and theoretical water quality data of the current monitoring station is acquired.

In the embodiment of the present disclosure, the previous monitoring station may be understood as a monitoring station, the river water of which flows along with river water to the current monitoring station, which means that the previous monitoring station is an upstream monitoring station of the current monitoring station. For example, as shown in FIG. 2, when the current monitoring station is B, then the previous monitoring station is C, and when the current monitoring station is C, then the previous monitoring station is B.

In the embodiment of the present disclosure, the actual water quality data may be understood as real water quality data of the previous monitoring station, such as an actual phosphorus concentration and an actual nitrogen concentration.

In the embodiment of the present disclosure, the actual water quality data may be water quality data acquired by the water quality sensor of the previous monitoring station.

Further, the actual water quality data is calculated through the calculated one-dimensional steady-state river model, and the theoretical water quality data of the current monitoring station is acquired. An actual flow velocity and a cross-section distance in the calculated one-dimensional steady-state river model may be adjusted in real time according to requirements, thus further improving judgment accuracy.

The calculated one-dimensional steady-state river model is a mathematical model with an initial point pollutant concentration as a variable and an end point pollutant concentration as a calculation result, and other parameters in the model have been acquired by pre-calculation. A mode of acquiring the parameters by pre-calculation of the one-dimensional steady-state river model will be described in detail later, which will not be repeated herein.

In the embodiment of the present disclosure, it can be understood that, the water quality data includes a phosphorus concentration, a nitrogen concentration, and the like, and in order to improve the judgment accuracy, concentrations of multiple pollutants may be calculated at the same time, so as to acquire the theoretical water quality data, which includes a theoretical phosphorus concentration, a theoretical nitrogen concentration, and the like of the current monitoring station.

In step 103, whether pollution emission occurs between the current monitoring station and the previous monitoring station is determined according to a comparison result of the currently monitored water quality data and the theoretical water quality data.

In the embodiment of the present disclosure, there are many mode of determining whether the pollution emission occurs between the current monitoring station and the previous monitoring station according to the comparison result of the currently monitored water quality data and the theoretical water quality, and examples are made as follows.

For a first example, a current pollution value of each pollutant is acquired from the current water quality data, a theoretical pollution value of each pollutant is acquired from the theoretical water quality data, difference values between the current pollution values and the theoretical pollution values are calculated, and a target pollutant with the difference value greater than a preset difference value threshold is acquired. When the target pollutant is in a preset pollutant list, it is determined that the pollutant is discharged between the current monitoring station and the previous monitoring station, and when the target pollutant is not in the preset pollutant list, it is determined that no pollutant is discharged between the current monitoring station and the previous monitoring station.

Specifically, the pollution difference of each pollutant in the water quality data is calculated, and pollutants exceeding a standard are determined in advance to determine the pollution emission. For example, the preset pollutant list includes phosphorus and nitrogen, and the pollutants are selected and set according to an application requirement.

For a second example, a current pollution value of a target pollutant is acquired from the current water quality data, a theoretical pollution value of the target pollutant is acquired from the theoretical water quality data, and a difference value between the current pollution value and the theoretical pollution value is calculated. When the difference value is greater than a preset difference value threshold, it is determined that the pollutant is discharged between the current monitoring station and the previous monitoring station, and when the difference value is smaller than or equal to the preset difference value threshold, it is determined that no pollutant is discharged between the current monitoring station and the previous monitoring station.

Specifically, pollutants exceeding a standard are determined first to determine pollution emission. For example, the target pollutants are phosphorus and nitrogen, corresponding difference values of the phosphorus and the nitrogen are calculated only, and when the difference values are greater than the preset difference value threshold, it is determined that the pollutants are discharged between the current monitoring station and the previous monitoring station, thus improving a calculation efficiency.

To sum up, in the pollution emission determination method based on the digital watershed space-time model of the present disclosure, the to-be-detected river watershed includes the plurality of sections, each section is provided with the monitoring station, the water quality sensor is mounted on each monitoring station, and the water quality sensor is used for acquiring the water quality data; and the method includes: acquiring the currently monitored water quality data of the current monitoring station; acquiring the actual water quality data of the previous monitoring station, calculating the actual water quality data through the calculated one-dimensional steady-state river model, and acquiring the theoretical water quality data of the current monitoring station; and determining whether the pollution emission occurs between the current monitoring station and the previous monitoring station according to the comparison result of the currently monitored water quality data and the theoretical water quality data. Therefore, the water quality pollution condition is judged in real time, and the pollution condition is effectively predicted and traced.

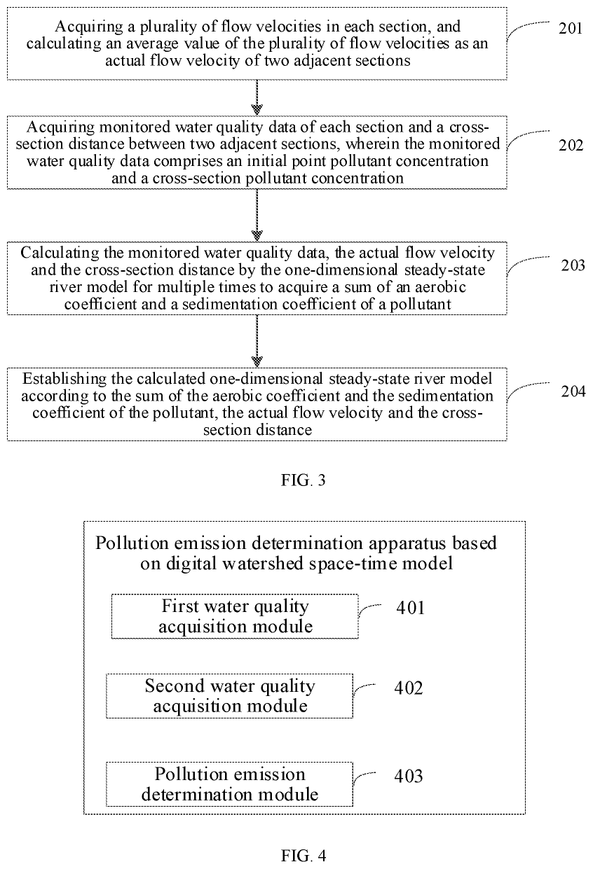

In a possible implementation mode of the present disclosure, before calculating the actual water quality data through the calculated one-dimensional steady-state river model, the one-dimensional steady-state river model is calculated in advance, which is specifically described with reference to FIG. 3, and as shown in FIG. 3, includes the following steps.

In step 201, a plurality of flow velocities in each section are acquired, and an average value of the plurality of flow velocities is calculated as an actual flow velocity of two adjacent sections.

In step 202, monitored water quality data of each section and a cross-section distance between two adjacent sections are acquired, wherein the monitored water quality data includes an initial point pollutant concentration and a cross-section pollutant concentration.

In step 203, the monitored water quality data, the actual flow velocity and the cross-section distance are calculated by the one-dimensional steady-state river model for multiple times to acquire a sum of an aerobic coefficient and a sedimentation coefficient of a pollutant.

In step 204, the calculated one-dimensional steady-state river model is established according to the sum of the aerobic coefficient and the sedimentation coefficient of the pollutant, the actual flow velocity and the cross-section distance.

Specifically, the one-dimensional steady-state river model is as follows:

$$c = {c}_{0} e p [ - ( {K}_{1} + {K}_{3} ) \frac{x}{86400 μ} ] . \qquad ( 1 )$$

c is the cross-section pollutant concentration, in a unit of mg/L, c₀ is the initial point pollutant concentration, in a unit of mg/L, c and c₀ are the monitored water quality data, K₁ is the aerobic coefficient, in a unit of 1/d, K₃ is the sedimentation coefficient of the pollutant, in a unit of 1/d, μ is the actual flow velocity, in a unit of m/s, and x is the cross-section distance (a distance from an initial point of calculation to a downstream cross-section of calculation), in a unit of m.

It should be noted that applicable conditions of the one-dimensional steady-state river model meet the following conditions: (1) a fully mixed section of river; (2) a non-persistent pollutant; (3) constant flowing of river; and (4) continuous and stable discharge of wastewater.

It should be noted that, for the persistent pollutant, in a river with an obvious sedimentation effect, a comprehensive reduction coefficient K may be used instead of K₁+K₃ in the above formula to predict a change of pollutant concentration along the river, thus further improving an accuracy.

Specifically, a flow velocity between monitoring points is collected by a velocity meter, and in order to ensure an accuracy of flow velocity in a section, velocities at multiple points in the section may be measured, and then an average value is obtained to represent a flow velocity level in the section, which is namely the actual flow velocity above. Combined with the water quality data measured at each monitoring point, the sum of the aerobic coefficient of each section and the sedimentation coefficient of the pollutant may be obtained through the one-dimensional steady-state river model, which is namely K₁+K₃. The watershed section may be digitalized by using the monitored initial water quality data of each section, the sum of the aerobic coefficient and the sedimentation coefficient of the pollutant, and the distance from each section to an initial point.

In the embodiment of the present disclosure, initial water quality data of any target section is acquired, the initial water quality data is calculated through the calculated one-dimensional steady-state river model, last water quality data of the target section is acquired, and initial water quality data of next section is acquired. When the last water quality data is inconsistent with the initial water quality data of the next section, the sum of the aerobic coefficient and the sedimentation coefficient of the pollutant is adjusted until an error between the last water quality data and the initial water quality data of the next section is within a preset threshold.

Specifically, the last water quality data of the section measured through the one-dimensional steady-state river model is very likely to be inconsistent with the monitored initial point water quality data of the next section, K₁+K₃ may be infinitely close to a real value by constant verification, and the measured water quality data can meet the accuracy within a certain range through experience of historical data. In this way, the whole watershed may be digitalized.

In a possible implementation mode of the present disclosure, when it is determined that the pollution emission occurs between the current monitoring station and the previous monitoring station, early warning information is generated and sent to a target device.

The target device is any device with computing power, such as a PC (Personal Computer) and a mobile terminal, and the mobile terminal, such as a mobile phone, a tablet computer, a personal digital assistant, a wearable device and other hardware devices with various operating systems, touch screens and/or display screens, is specifically selected and set according to an application scene.

The early warning information may include the section, the monitoring station, the pollutant concentration, time, and the like, and is specifically selected and set according to the application scene.

In a possible implementation mode of the present disclosure, when it is determined that the pollution emission occurs between the current monitoring station and the previous monitoring station, a distance between the current monitoring station and the previous monitoring station is acquired, when the distance is smaller than a preset distance threshold, industry information within the distance is acquired, and a target region of pollutant emission is determined according to the industrial information.

Specifically, preliminary judgment may be made by using the monitored water quality data of each monitoring station, and when natural extinction of the pollutant during water flow is ignored, if the pollutant concentration of the current monitoring station is much greater than that of the previous monitoring station, it is judged that there are emission without permission and evaded emission in the cross-section of the watershed.

It should be noted that when the judgment cannot be made by the above mode, the natural extinction of the pollutant during water flow may be considered. After a long time of study, K₁+K₃ has been able to accurately describe the whole watershed, a theoretical value of the pollutant concentration of the current monitoring station may be calculated by the one-dimensional steady-state river model through the pollutant concentration of the previous monitoring station, and comparing the theoretical value with an actual monitored value of the current monitoring station, if the calculated theoretical value is far smaller than the actual monitored value, there is every reason to believe that there are emission without permission and evaded emission in the section. Moreover, early warning may be given to a section where the calculated theoretical value is slightly smaller than the actual monitored value.

As an example of a scene, continuously referring to FIG. 2, a water quality process at any time and position from B to C may be deduced by the one-dimensional steady-state river model through actual water quality data of the monitoring point B in FIG. 2. After comparing theoretical water quality data at C calculated by the one-dimensional steady-state river model with actual theoretical water quality data at C, if a calculated value is far smaller than an actual value, it is indicated that there are emission without permission and evaded emission of sewage between B and C sections. If a distance between the B and C sections is short, in combination with industrial conditions around the section, such as a production enterprise in the section, a production time and a product type, a surrounding region of an enterprise involving in emission without permission and evaded emission may be better targeted.

Therefore, data collection by the sensor is real-time, so that a real-time pollutant concentration condition may be obtained, and the monitoring stations may be compared in real time by calculating the theoretical water quality data of the monitoring points in real time, so that the section involving in emission without permission and evaded emission is targeted, and the polluted section is supervised and inspected, thus achieving the purpose of tracing a source. In addition, with an increase of density of the monitoring stations arranged, learning of related parameters will be continuously optimized, and the accuracy will also be higher and higher, so that an inspection efficiency of emission without permission and evaded emission is effectively improved.

FIG. 4 is a schematic structural diagram of a pollution emission determination apparatus based on a digital watershed space-time model in the embodiment of the present disclosure. The apparatus may be implemented by software and/or hardware, and may be generally integrated in an electronic device. As shown in FIG. 4, a to-be-detected river watershed includes a plurality of sections, each section is provided with a monitoring station, a water quality sensor is mounted on each monitoring station, and the water quality sensor is used for acquiring water quality data; and the apparatus includes the following modules.

A first water quality acquisition module 401 is configured for acquiring currently monitored water quality data of a current monitoring station.

A second water quality acquisition module 402 is configured for acquiring actual water quality data of a previous monitoring station, calculating the actual water quality data through a calculated one-dimensional steady-state river model, and acquiring theoretical water quality data of the current monitoring station.

A pollution emission determination module 403 is configured for determining whether pollution emission occurs between the current monitoring station and the previous monitoring station according to a comparison result of the currently monitored water quality data and the theoretical water quality data.

In an optional embodiment of the present disclosure, the apparatus further includes: a flow velocity acquisition module configured for acquiring a plurality of flow velocities in each section, and calculating an average value of the plurality of flow velocities as an actual flow velocity of two adjacent sections; a water quality and distance acquisition module configured for acquiring monitored water quality data of each section and a cross-section distance between two adjacent sections, wherein the monitored water quality data includes an initial point pollutant concentration and a cross-section pollutant concentration; a calculation module configured for calculating the monitored water quality data, the actual flow velocity and the cross-section distance by the one-dimensional steady-state river model for multiple times to acquire a sum of an aerobic coefficient and a sedimentation coefficient of a pollutant; and an establishment module configured for establishing the calculated one-dimensional steady-state river model according to the sum of the aerobic coefficient and the sedimentation coefficient of the pollutant, the actual flow velocity and the cross-section distance.

In an optional embodiment of the present disclosure, the apparatus further includes: an acquisition and calculation module configured for acquiring initial water quality data of any target section, calculating the initial water quality data through the calculated one-dimensional steady-state river model, and acquiring last water quality data of the target section; an acquisition module configured for acquiring initial water quality data of next section; and an adjustment module configured for, when the last water quality data is inconsistent with the initial water quality data of the next section, adjusting the sum of the aerobic coefficient and the sedimentation coefficient of the pollutant until an error between the last water quality data and the initial water quality data of the next section is within a preset threshold.

In an optional embodiment of the present disclosure, the pollution emission determination module 403 is specifically configured for acquiring a current pollution value of each pollutant from the current water quality data, acquiring a theoretical pollution value of each pollutant from the theoretical water quality data, calculating difference values between the current pollution values and the theoretical pollution values, acquiring a target pollutant with the difference value greater than a preset difference value threshold, when the target pollutant is in a preset pollutant list, determining that the pollution emission occurs between the current monitoring station and the previous monitoring station, and when the target pollutant is not in the preset pollutant list, determining that no pollution emission occurs between the current monitoring station and the previous monitoring station.

In an optional embodiment of the present disclosure, the pollution emission determination module is specifically configured for acquiring a current pollution value of a target pollutant from the current water quality data, acquiring a theoretical pollution value of the target pollutant from the theoretical water quality data, calculating a difference value between the current pollution value and the theoretical pollution value, when the difference value is greater than a preset difference value threshold, determining that the pollution emission occurs between the current monitoring station and the previous monitoring station, and when the difference value is smaller than or equal to the preset difference value threshold, determining that no pollution emission occurs between the current monitoring station and the previous monitoring station.

In an optional embodiment of the present disclosure, the apparatus further includes: a generation and sending module configured for, when it is determined that the pollution emission occurs between the current monitoring station and the previous monitoring station, generating early warning information and sending the early warning information to a target device.

In an optional embodiment of the present disclosure, the apparatus further includes: an analysis module configured for, when it is determined that the pollution emission occurs between the current monitoring station and the previous monitoring station, acquiring a distance between the current monitoring station and the previous monitoring station, when the distance is smaller than a preset distance threshold, acquiring industry information within the distance, and determining a target region of pollutant emission according to the industrial information.

To sum up, in the pollution emission determination apparatus based on the digital watershed space-time model of the present disclosure, the to-be-detected river watershed includes the plurality of sections, each section is provided with the monitoring station, the water quality sensor is mounted on each monitoring station, and the water quality sensor is used for acquiring the water quality data; and the method includes: acquiring the currently monitored water quality data of the current monitoring station; acquiring the actual water quality data of the previous monitoring station, calculating the actual water quality data through the calculated one-dimensional steady-state river model, and acquiring the theoretical water quality data of the current monitoring station; and determining whether the pollution emission occurs between the current monitoring station and the previous monitoring station according to the comparison result of the currently monitored water quality data and the theoretical water quality data. Therefore, the water quality pollution condition is judged in real time, and the pollution condition is effectively predicted and traced.

The embodiment of the present disclosure further provides a computer storage medium, wherein the computer storage medium may store a program, and when the program is executed, some or all steps in various implementation modes of the pollution emission determination method based on the digital watershed space-time model provided by the embodiment as shown in FIG. 1 to FIG. 3 may be realized.

The embodiment of the present disclosure further provides an electronic device, wherein the electronic device includes:
a processor; and
a storage for storing an executable instruction of the processor;
wherein the processor is configured for:
acquiring currently monitored water quality data of a current monitoring station;
acquiring actual water quality data of a previous monitoring station, calculating the actual water quality data through a calculated one-dimensional steady-state river model, and acquiring theoretical water quality data of the current monitoring station; and
determining whether pollution emission occurs between the current monitoring station and the previous monitoring station according to a comparison result of the currently monitored water quality data and the theoretical water quality data.

It should be noted that relational terms, such as “first” and “second”, and the like, used herein are only intended to distinguish one entity or operation from another entity or operation, and do not necessarily require or imply that any such actual relationship or sequence exists between these entities or operations. Furthermore, the terms “comprise”, “include”, or any other variation thereof, are intended to cover a non-exclusive inclusion, so that a process, a method, an article, or equipment that includes a list of elements not only includes those elements but also includes other elements not expressly listed, or further includes elements inherent to such process, method, article, or equipment. In a case without further limitations, an element defined by the phrase “comprising one . . . ” does not preclude the presence of additional identical elements in the process, method, article, or equipment that includes the element.

The foregoing descriptions are only specific embodiments of the present disclosure, such that those skilled in the art can understand or realize the present disclosure. Many modifications to these embodiments will be obvious to those skilled in the art, and general principles defined herein may be realized in other embodiments without departing from the spirit or scope of the present disclosure. Therefore, the present disclosure will not be limited to these embodiments shown herein, but should comply with the widest scope consistent with the principles and novel features disclosed herein.

What is claimed is:

1. A pollution emission determination method based on a digital watershed space-time model, wherein a to-be-detected river watershed comprises a plurality of sections, each section of the plurality of sections is provided with a monitoring station, a water quality sensor is mounted on the monitoring station, and the water quality sensor is used for acquiring water quality data; and the pollution emission determination method comprises:
acquiring currently monitored water quality data of a current monitoring station;
acquiring actual water quality data of a previous monitoring station, calculating the actual water quality data through a calculated one-dimensional steady-state river model, and acquiring theoretical water quality data of the current monitoring station; and
determining whether pollution emission occurs between the current monitoring station and the previous monitoring station according to a comparison result of the currently monitored water quality data and the theoretical water quality data.

2. The pollution emission determination method based on the digital watershed space-time model according to claim 1, wherein before calculating the actual water quality data through the calculated one-dimensional steady-state river model, the pollution emission determination method further comprises:
acquiring a plurality of flow velocities in each section, and calculating an average value of the plurality of flow velocities as an actual flow velocity of two adjacent sections;
acquiring monitored water quality data of each section and a cross-section distance between two adjacent sections, wherein the monitored water quality data comprises an initial point pollutant concentration and a cross-section pollutant concentration;
calculating the monitored water quality data, the actual flow velocity and the cross-section distance by the one-dimensional steady-state river model for multiple times to acquire a sum of an aerobic coefficient and a sedimentation coefficient of a pollutant; and
establishing the calculated one-dimensional steady-state river model according to the sum of the aerobic coefficient and the sedimentation coefficient of the pollutant, the actual flow velocity and the cross-section distance.

3. The pollution emission determination method based on the digital watershed space-time model according to claim 2, further comprising:
acquiring initial water quality data of any target section, calculating the initial water quality data through the calculated one-dimensional steady-state river model, and acquiring last water quality data of the target section;
acquiring initial water quality data of a next section; and
when the last water quality data is inconsistent with the initial water quality data of the next section, adjusting the sum of the aerobic coefficient and the sedimentation coefficient of the pollutant until an error between the last water quality data and the initial water quality data of the next section is within a preset threshold.

4. The pollution emission determination method based on the digital watershed space-time model according to claim 1, wherein the step of determining whether the pollution emission occurs between the current monitoring station and the previous monitoring station according to the comparison result of the currently monitored water quality data and the theoretical water quality data, comprises:
acquiring a current pollution value of each pollutant from the currently monitored water quality data;
acquiring a theoretical pollution value of each pollutant from the theoretical water quality data;
calculating difference values between current pollution values and theoretical pollution values, and acquiring a target pollutant with a difference value greater than a preset difference value threshold;
when the target pollutant is in a preset pollutant list, determining that the pollution emission occurs between the current monitoring station and the previous monitoring station; and
when the target pollutant is not in the preset pollutant list, determining that no pollution emission occurs between the current monitoring station and the previous monitoring station.

5. The pollution emission determination method based on the digital watershed space-time model according to claim 1, wherein the step of determining whether the pollution emission occurs between the current monitoring station and the previous monitoring station according to the comparison result of the currently monitored water quality data and the theoretical water quality data, comprises:
acquiring a current pollution value of a target pollutant from the currently monitored water quality data;
acquiring a theoretical pollution value of the target pollutant from the theoretical water quality data;
calculating a difference value between the current pollution value and the theoretical pollution value, and when the difference value is greater than a preset difference value threshold, determining that the pollution emission occurs between the current monitoring station and the previous monitoring station; and
when the difference value is smaller than or equal to the preset difference value threshold, determining that no pollution emission occurs between the current monitoring station and the previous monitoring station.

6. The pollution emission determination method based on the digital watershed space-time model according to claim 4, further comprising:
when it is determined that the pollution emission occurs between the current monitoring station and the previous monitoring station, generating early warning information and sending the early warning information to a target device.

7. The pollution emission determination method based on the digital watershed space-time model according to claim 4, further comprising:
when it is determined that the pollution emission occurs between the current monitoring station and the previous monitoring station, acquiring a distance between the current monitoring station and the previous monitoring station;
when the distance is smaller than a preset distance threshold, acquiring industry information within the distance; and
determining a target region of pollutant emission according to the industrial information.

8. A pollution emission determination apparatus based on a digital watershed space-time model, wherein a to-be-detected river watershed comprises a plurality of sections, each section of the plurality of sections is provided with a monitoring station, a water quality sensor is mounted on the monitoring station, and the water quality sensor is used for acquiring water quality data; and the pollution emission determination apparatus comprises:
a first water quality acquisition module configured for acquiring currently monitored water quality data of a current monitoring station;
a second water quality acquisition module configured for acquiring actual water quality data of a previous monitoring station, calculating the actual water quality data through a calculated one-dimensional steady-state river model, and acquiring theoretical water quality data of the current monitoring station; and
a pollution emission determination module configured for determining whether pollution emission occurs between the current monitoring station and the previous monitoring station according to a comparison result of the currently monitored water quality data and the theoretical water quality data.

9. An electronic device, wherein the electronic device comprises:
a processor; and
a storage for storing an executable instruction of the processor;
wherein the processor is used for reading the executable instruction from the storage and executing the executable instruction to realize the pollution emission determination method based on the digital watershed space-time model according to claim 1.

10. A computer-readable storage medium, wherein the computer-readable storage medium stores a computer program, and the computer program is used for executing the pollution emission determination method based on the digital watershed space-time model according to claim 1.

11. The pollution emission determination method based on the digital watershed space-time model according to claim 5, further comprising:
when it is determined that the pollution emission occurs between the current monitoring station and the previous monitoring station, generating early warning information and sending the early warning information to a target device.

12. The pollution emission determination method based on the digital watershed space-time model according to claim 5, further comprising:
when it is determined that the pollution emission occurs between the current monitoring station and the previous monitoring station, acquiring a distance between the current monitoring station and the previous monitoring station;
when the distance is smaller than a preset distance threshold, acquiring industry information within the distance; and
determining a target region of pollutant emission according to the industrial information.

13. The electronic device according to claim 9, wherein before calculating the actual water quality data through the calculated one-dimensional steady-state river model, the pollution emission determination method further comprises:
acquiring a plurality of flow velocities in each section, and calculating an average value of the plurality of flow velocities as an actual flow velocity of two adjacent sections;
acquiring monitored water quality data of each section and a cross-section distance between two adjacent sections, wherein the monitored water quality data comprises an initial point pollutant concentration and a cross-section pollutant concentration;
calculating the monitored water quality data, the actual flow velocity and the cross-section distance by the one-dimensional steady-state river model for multiple times to acquire a sum of an aerobic coefficient and a sedimentation coefficient of a pollutant; and
establishing the calculated one-dimensional steady-state river model according to the sum of the aerobic coefficient and the sedimentation coefficient of the pollutant, the actual flow velocity and the cross-section distance.

14. The electronic device according to claim 13, wherein the pollution emission determination method further comprises:
acquiring initial water quality data of any target section, calculating the initial water quality data through the calculated one-dimensional steady-state river model, and acquiring last water quality data of the target section;
acquiring initial water quality data of a next section; and
when the last water quality data is inconsistent with the initial water quality data of the next section, adjusting the sum of the aerobic coefficient and the sedimentation coefficient of the pollutant until an error between the last water quality data and the initial water quality data of the next section is within a preset threshold.

15. The electronic device according to claim 9, wherein the step of determining whether the pollution emission occurs between the current monitoring station and the previous monitoring station according to the comparison result of the currently monitored water quality data and the theoretical water quality data, comprises:
acquiring a current pollution value of each pollutant from the currently monitored water quality data;
acquiring a theoretical pollution value of each pollutant from the theoretical water quality data;
calculating difference values between current pollution values and theoretical pollution values, and acquiring a target pollutant with a difference value greater than a preset difference value threshold;
when the target pollutant is in a preset pollutant list, determining that the pollution emission occurs between the current monitoring station and the previous monitoring station; and
when the target pollutant is not in the preset pollutant list, determining that no pollution emission occurs between the current monitoring station and the previous monitoring station.

16. The electronic device according to claim 9, wherein the step of determining whether the pollution emission occurs between the current monitoring station and the previous monitoring station according to the comparison result of the currently monitored water quality data and the theoretical water quality data, comprises:
acquiring a current pollution value of a target pollutant from the currently monitored water quality data;
acquiring a theoretical pollution value of the target pollutant from the theoretical water quality data;
calculating a difference value between the current pollution value and the theoretical pollution value, and when the difference value is greater than a preset difference value threshold, determining that the pollution emission occurs between the current monitoring station and the previous monitoring station; and
when the difference value is smaller than or equal to the preset difference value threshold, determining that no pollution emission occurs between the current monitoring station and the previous monitoring station.

17. The electronic device according to claim 15, wherein the pollution emission determination method further comprises:
when it is determined that the pollution emission occurs between the current monitoring station and the previous monitoring station, generating early warning information and sending the early warning information to a target device.

18. The electronic device according to claim 15, wherein the pollution emission determination method further comprises:
when it is determined that the pollution emission occurs between the current monitoring station and the previous monitoring station, acquiring a distance between the current monitoring station and the previous monitoring station;
when the distance is smaller than a preset distance threshold, acquiring industry information within the distance; and
determining a target region of pollutant emission according to the industrial information.

19. The computer-readable storage medium according to claim 10, wherein before calculating the actual water quality data through the calculated one-dimensional steady-state river model, the pollution emission determination method further comprises:
acquiring a plurality of flow velocities in each section, and calculating an average value of the plurality of flow velocities as an actual flow velocity of two adjacent sections;
acquiring monitored water quality data of each section and a cross-section distance between two adjacent sections, wherein the monitored water quality data comprises an initial point pollutant concentration and a cross-section pollutant concentration;
calculating the monitored water quality data, the actual flow velocity and the cross-section distance by the one-dimensional steady-state river model for multiple times to acquire a sum of an aerobic coefficient and a sedimentation coefficient of a pollutant; and
establishing the calculated one-dimensional steady-state river model according to the sum of the aerobic coefficient and the sedimentation coefficient of the pollutant, the actual flow velocity and the cross-section distance.

20. The computer-readable storage medium according to claim 19, wherein the pollution emission determination method further comprises:
acquiring initial water quality data of any target section, calculating the initial water quality data through the calculated one-dimensional steady-state river model, and acquiring last water quality data of the target section;
acquiring initial water quality data of a next section; and
when the last water quality data is inconsistent with the initial water quality data of the next section, adjusting the sum of the aerobic coefficient and the sedimentation coefficient of the pollutant until an error between the last water quality data and the initial water quality data of the next section is within a preset threshold.
